(19) United States
(12) Patent Application Publication
(10) Pub. No.: US 2018/0182538 A1
(43) Pub. Date: Jun. 28, 2018

(54) COIL COMPONENT AND METHOD OF MANUFACTURING THE SAME

(71) Applicant: SAMSUNG ELECTRO-MECHANICS CO., LTD., Suwon-si (KR)

(72) Inventor: Youn Kyu CHOI, Suwon-si (KR)

(21) Appl. No.: 15/717,258

(22) Filed: Sep. 27, 2017

(30) Foreign Application Priority Data
Dec. 22, 2016 (KR) 10-2016-0177126

(51) Int. Cl. H01F 27/29; H01F 27/28; H01F 27/245; H01F 27/255; H01F 41/076; H01F 41/02; H01F 41/10

(52) U.S. Cl. CPC H01F 27/292; H01F 27/2828; H01F 27/245; H01F 41/10; H01F 41/076; H01F 41/0233; H01F 27/255

(57) ABSTRACT

A coil component includes a winding type coil having at least one lead terminal and a body covering the coil and including a magnetic material and a conductive resin applied to an end portion of the lead terminal. An electrode is on the body and connected to the lead terminal and to the conductive resin.

### CROSS-REFERENCE TO RELATED APPLICATION(S)

This application claims benefit of priority to Korean Patent Application No. 10-2016-0177126 filed on Dec. 22, 2016 in the Korean Intellectual Property Office, the disclosure of which is incorporated herein by reference in its entirety.

### BACKGROUND

### 1. Field

The present disclosure relates to a coil component and a method of manufacturing the same.

### 2. Description of Related Art

Coil components have mainly been winding type coil components manufactured in a relatively simple method. Winding type coil components have generally been manufactured in a mold method of disposing a winding coil in a mold, filling a molding material in the mold, and then hardening the molding material.

As current and inductance of coil components have increased, the contact area of the connection portion between an internal coil and an external electrode has narrowed. In winding type coil components manufactured in the mold method, short-circuits or open circuits may occur between the internal coil and the external electrode, for example due to thermal shock caused by the narrow area, which may cause problems such as increased interfacial resistance, deterioration of desired characteristics, or the like.

### SUMMARY

An aspect of the present disclosure may provide a coil component in which reliability of connection between an internal coil and an external electrode may be improved, and a method of manufacturing the same.

According to an aspect of the present disclosure, a coil component may be provided, in which a conductive resin is applied to an end portion of a lead terminal of a winding coil in a body of the coil component.

According to an aspect of the present disclosure, a coil component may include a winding type coil having at least one lead terminal. A body may cover the coil and include a magnetic material and a conductive resin applied to an end portion of the lead terminal. An electrode may be on the body and connected to the lead terminal and to the conductive resin.

According to another aspect of the present disclosure, a method of manufacturing a coil component may include the following. A support member having a plurality of through-holes may be prepared. Coils may be disposed in the plurality of through-holes of the support member, respectively, the coils being formed as a winding type and having at least one lead terminal. Conductive resins may be applied to end portions of the lead terminals of the coils, respectively. A plurality of bodies respectively covering the coils may be formed by compressing and hardening magnetic sheets including a magnetic material on upper and lower surfaces of the support member. The plurality of bodies may be cut so that cut surfaces are formed on the end portions of the lead terminals and the conductive resins. Electrodes may be formed on the cut bodies, the electrodes being connected to the lead terminals and the conductive resins.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic view illustrating an example of an electronic device including coil components;

FIG. 2 is a schematic perspective view illustrating an exemplary a coil component;

FIG. 3 is a schematic plan view illustrating forms of an inner portion and an outer portion of a body of the coil component of FIG. 2 when viewed in direction A of FIG. 2;

FIG. 4 is a schematic cross-sectional view illustrating the forms of the inner portion and the outer portion of the body of the coil component of FIG. 2 taken along line I-I′ of FIG. 2;

FIG. 5 is a schematic flow chart illustrating an exemplary manufacturing process for the coil component of FIG. 2; and

FIGS. 6A through 6F are schematic views illustrating an exemplary manufacturing process for the coil component of FIG. 2.

### DETAILED DESCRIPTION

Hereinafter, exemplary embodiments in the present disclosure will be described in more detail with reference to the accompanying drawings. In the drawings, shapes, sizes, and the like, of components may be exaggerated for clarity.

Meanwhile, in the present disclosure, the meaning of an “electrical connection” of one component to another component includes one component being physically connected to another component and includes one component not physically connected to another component. It can be understood that when an element is referred to with “first” and “second”, the element is not limited thereby. They may be used only for a purpose of distinguishing the element from the other elements, and may not limit the sequence or importance of the elements. In some cases, a first element may be referred to as a second element without departing from the scope of the claims set forth herein. Similarly, a second element may also be referred to as a first element.

In addition, a term “example” used in the present disclosure does not mean the same exemplary embodiment, but may be provided in order to emphasize and describe different unique features. However, exemplary embodiments provided herein are considered to be able to be implemented by being combined in whole or in part one with another. For example, one element described in a particular exemplary embodiment, even if it is not described in another exemplary embodiment, may be understood as a description related to another exemplary embodiment, unless an opposite or contradictory description is provided therein.

Terms used in the present disclosure are used only in order to describe an example rather than necessarily limiting the scope of the present disclosure.

Electronic Device

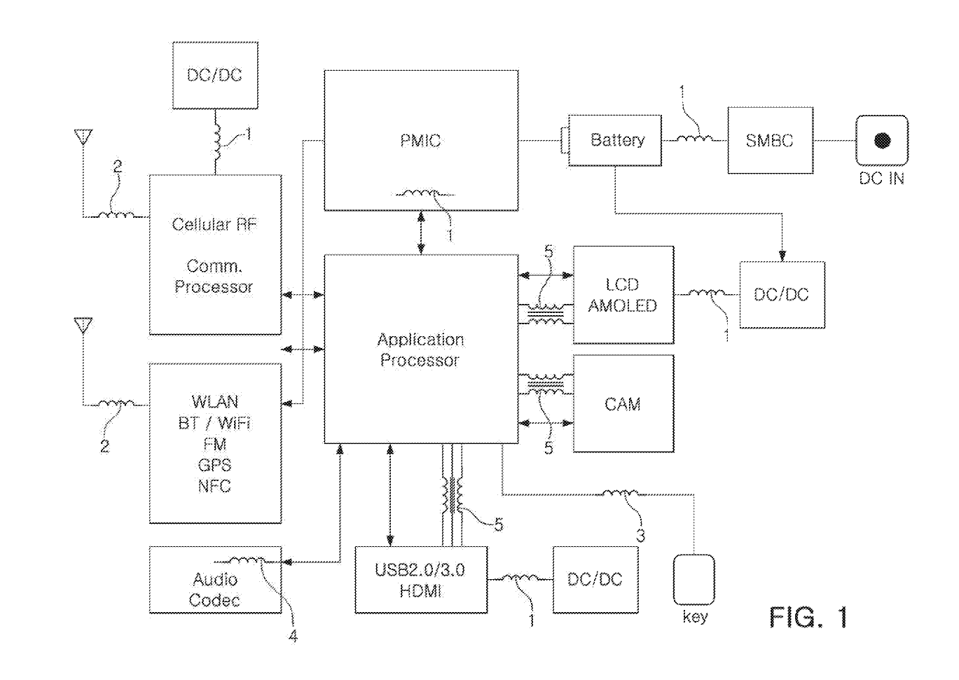

FIG. 1 is a schematic view illustrating an example of an electronic device including coil components.

Referring to the drawing, it may be appreciated that various kinds of electronic components are used in an electronic device. For example, an application processor, a direct current (DC) to DC converter, a communications processor, a wireless local area network Bluetooth (WLAN BT)/wireless fidelity frequency modulation global positioning system near field communications (WiFi FM GPS NFC), a power management integrated circuit (PMIC), a battery, an SMBC, a liquid crystal display active matrix organic light emitting diode (LCD AMOLED), an audio codec, a universal serial bus (USB) 2.0/3.0, a high definition multimedia interface (HDMI), a CAM, and the like, may be used. Various kinds of coil components may be appropriately used between these electronic components depending on their purposes in order to remove noise, or the like. For example, a power inductor 1, high frequency (HF) inductors 2, a general bead 3, a bead 4 for a high frequency (GHz), common mode filters 5, and the like, may be used.

The power inductor 1 may be used to store electricity in magnetic fields to maintain an output voltage, thereby stabilizing power. The high frequency (HF) inductor 2 may be used to perform impedance matching to secure a required frequency or cut off noise and an alternating current (AC) component. The general bead 3 may be used to remove noise of power and signal lines or remove a high frequency ripple. The bead 4 for a high frequency (GHz) may be used to remove high frequency noise of a signal line and a power line related to an audio. The common mode filter 5 may be used to pass a current therethrough in a differential mode and remove only common mode noise.

An electronic device may be a smartphone, but is not limited thereto, and may also be, for example, a personal digital assistant, a digital video camera, a digital still camera, a network system, a computer, a monitor, a television, a video game system, or a smartwatch. The electronic device may also be various other electronic devices well-known to those skilled in the art, in addition to the devices described above.

Coil Component

Hereinafter, a coil component according to the present disclosure, particularly, an inductor will be described for convenience of explanation. However, the coil component according to the present disclosure may also be applied as the coil components for various purposes as described above. In the following discussion, a side portion refers to a portion facing toward a first direction or a second direction, and upper and lower portions refer to portions facing each other in a third direction. The phrase “positioned at the side portion, the upper portion, or the lower portion” includes the target component positioned in a corresponding direction, but does not directly contact a reference component, as well where the target component directly contacts the reference component in the corresponding direction. However, these directions are defined for convenience of explanation, and the claims are not necessarily limited by the directions defined as described above.

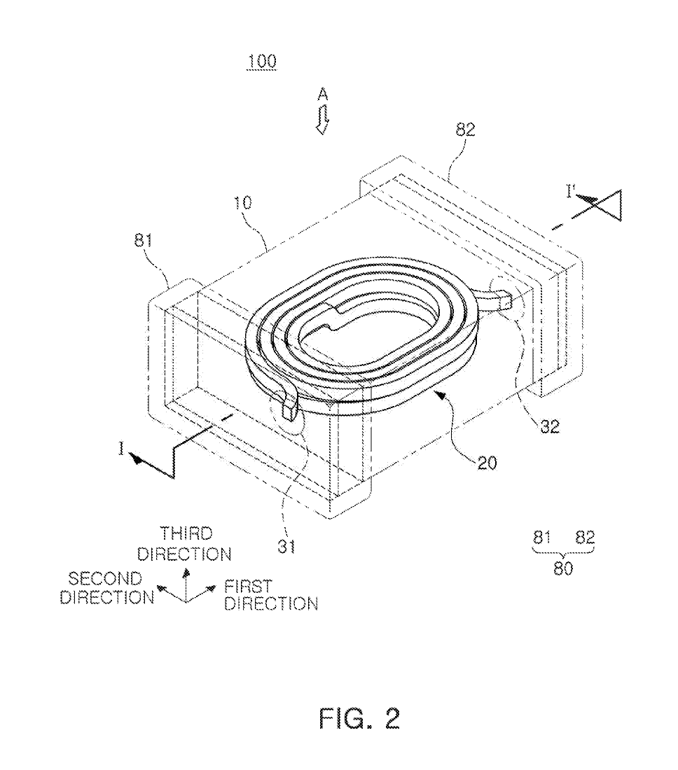

FIG. 2 is a schematic perspective view illustrating an exemplary coil component.

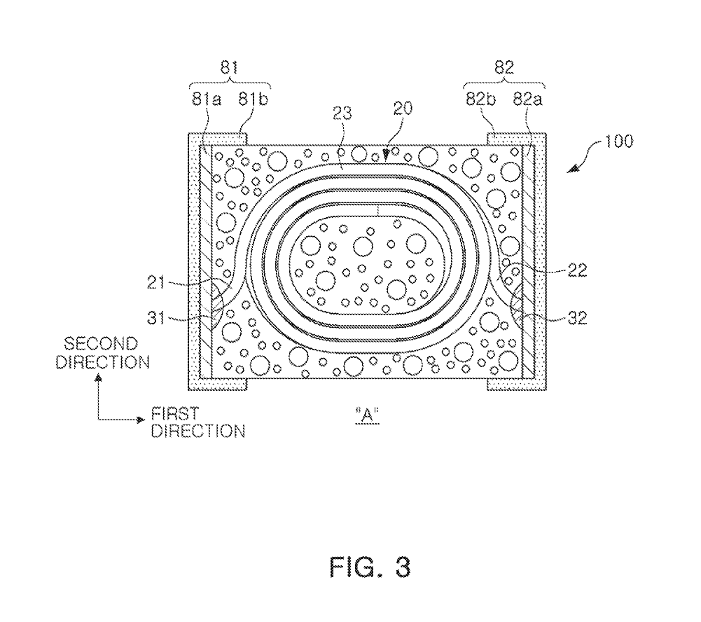

FIG. 3 is a schematic plan view illustrating forms of an inner portion and an outer portion of a body of the coil component of FIG. 2 when viewed in direction A of FIG. 2.

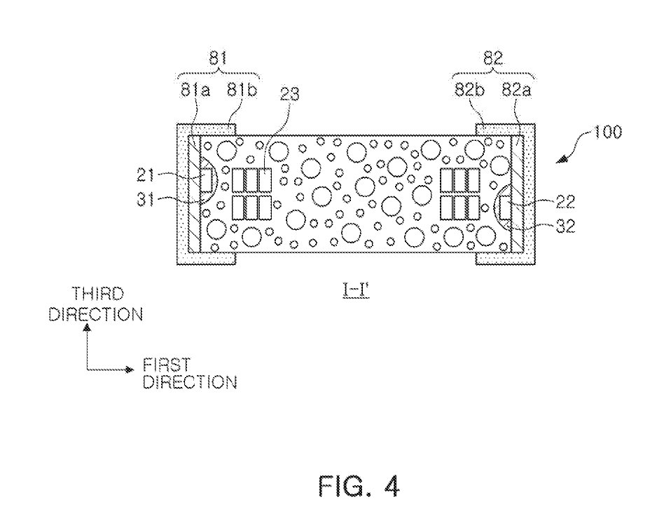

FIG. 4 is a schematic cross-sectional view illustrating the forms of the internal portion and the external portion of the body of the coil component of FIG. 2 taken along line I-I′ of FIG. 2.

Referring to the drawings, a coil component 100 according to an exemplary embodiment in the present disclosure may include a body 10, a coil 20 in the body 10, and electrodes 80 disposed on the body 10. The coil 20 may include first and second lead terminals 21 and 22. The electrodes 80 may include first and second external electrodes 81 and 82 respectively connected to the first and second lead terminals 21 and 22. First and second conductive resins 31 and 32 may be applied to end portions of the first and second lead terminals 21 and 22, respectively. The first and second conductive resins 31 and 32 may be disposed in the body 10, and may be connected to the end portions of the first and second lead terminals 21 and 22, respectively, and also connected to the first and second external electrodes 81 and 82, respectively.

As described above, as the current and inductance of coil components has increased, the contact area of the connection portion between an internal coil and an external electrode has narrowed. In winding type coil components manufactured by the mold method, short-circuits or open circuits occur between the internal coil and the external electrode due to thermal shock caused by the narrow area and cause problems such increased interfacial resistance, deterioration of characteristics, or the like. Short-circuits between the internal coil and the external electrode may occur due to thermal contraction of a resin such as epoxy resin, or the like, constituting a body at the time of performing surface-mount technology (SMT) soldering. Short-circuits between the internal coil and the external electrode may occur due to burn out occurring depending on a rapid increase in a voltage load at the time of high voltage sorting. Further, short-circuits or open circuits may also occur between the internal coil and the external electrode due to vibrations such as during transport, or the like. Defects or functional deterioration f a product may thus occur.

In the coil component 100 according to the exemplary embodiment, the conductive resins 31 and 32 may be applied, respectively, to the end portions of the lead terminals 21 and 22 of the coil 20 in the body. The conductive resins 31 and 32 may cover the end portions of the lead terminals 21 and 22, respectively, and may be in contact with the external electrodes 81 and 82, respectively. The conductive resins 31 and 32 may be electrically connected to the lead terminals 21 and 22, respectively, and also electrically connected to the external electrodes 81 and 82, respectively. Since connection areas between the lead terminals and the external electrodes are increased by the conductive resins 31 and 32, and the lead terminals 21 and 22 are fixed by the conductive resins 31 and 32, reliability of connections between the lead terminals 21 and 22 and the external electrodes 81 and 82 may be effectively improved. For example, short-circuits between the lead terminals 21 and 22 and the external electrodes 81 and 82 due to contraction of a resin constituting the body at a high temperature may be effectively suppressed. Dot solid matters of the conductive resins 31 and 32 may serve as a kind of anchor in the body 10 to provide a structure stable against stress.

Cut surfaces in contact with the external electrodes 81 and 82 may be formed on the conductive resins 31 and 32 and the end portions of the lead terminals 21 and 22. The cut surfaces of the lead terminals 21 and 22 and the cut surfaces of the conductive resins 31 and 32 may be coplanar to each other, and may be coplanar to end surfaces of the body 10 on which the external electrodes 81 and 82 are disposed. When the external electrodes 81 and 82 are formed on the cut surfaces that are flat and have wide contact areas, reliability of connection may be further improved. The axial direction of the coil 20, (the third direction) may be a height direction. The direction perpendicular to the axial direction of the coil 20 and parallel to the opposing surfaces of the body on which the external electrodes are disposed (the second direction) may be a width direction. The ratio of a height in the height direction to a width in the width direction is an aspect ratio. The cut surfaces of the lead terminals 21 and 22 may have quadrangular shapes with aspect ratios of 1 or more. In the present disclosure, the term ‘coplanar’ includes levels with a slight difference due to process errors, or the like, as well as levels that are completely the same as each other.

The respective components of the coil component 100 will hereinafter be described in more detail.

The body 10 may form an exterior of the coil component 100, and may have first and second surfaces opposing each other in the first direction, third and fourth surfaces opposing each other in the second direction, and fifth and sixth surfaces opposing each other in the third direction. The body 10 may have a hexahedral shape, but is not limited thereto. The body 10 may include a magnetic material. The magnetic material is not limited as long as it has magnetic properties, but may be, for example, iron and iron alloys such as a pure iron powder, and alloy powders based on Fe—Si, Fe—Si—Al, Fe—Ni, Fe—Ni—Mo, Fe—Ni—Mo—Cu, Fe—Co, Fe—Ni—Co, Fe—Cr, Fe—Cr—Si, Fe—Ni—Cr, Fe—Cr—Al, or the like, amorphous alloys such as an Fe-based amorphous alloy, a Co-based amorphous alloy, or the like, spinel type ferrites such as ferrites based on Mg—Zn, Mn—Zn, Mn—Mg, Cu—Zn, Mg—Mn—Sr, Ni—Zn, or the like, hexagonal ferrites such ferrites based on Ba—Zn, Ba—Mg, Ba—Ni, Ba—Co-based, Ba—Ni—Co, or the like, or garnet ferrites such as a Y-based ferrite, or the like.

The magnetic material of the body 10 may be a magnetic material-resin composite in which metal magnetic powder particles and a resin mixture are mixed with each other. The metal magnetic powder particles may include iron (Fe), chromium (Cr), or silicon (Si) as a main component. For example, the metal magnetic powder particles may include Fe—Ni, Fe, Fe—Cr—Si, or the like, but are not limited thereto. The resin mixture may contain epoxy, polyimide, liquid crystal polymer (LCP), or the like, but is not limited thereto. The metal magnetic powder particles may be metal magnetic powder particles having at least two average particle sizes. When bimodal or trimodal metal magnetic powder particles having different sizes are used, a packing factor may be increased.

End surfaces and side surfaces of the body 10, that is, the first to fourth surfaces of the body 10 may be cut surfaces. At least portions of the magnetic material such as the metal magnetic powder particles at the cut surfaces of the body 10 may be cut. For example, the metal magnetic powers at the cut surfaces may have planarized hemispherical shapes or spherical shapes of which portions are cut to be implemented to have flat surfaces, to prevent the concentration of plating current when applying the plating current.

The coil 20 may implement coil characteristics of the coil component 100. The coil 20 may be a winding coil including a plurality of layers, and the respective layers of the winding coil may have a plurality of turns. The respective layers of the winding coil may have a planar spiral shape, but is not limited thereto and may also have another shape. The coil 20 may have the first and second lead terminals 21 and 22, and the end portions of the first and second lead terminals 21 and 22 may be exposed, respectively, at opposing end surfaces of the body 10, for example, the first surface and the second surface of the body opposing each other in the first direction. The cut surfaces in contact with the external electrodes 81 and 82 may be formed on the end portions of the lead terminals 21 and 22. Here, the cut surfaces of the lead terminals 21 and 22 may have quadrangular shapes with aspect ratios of 1 or more, as described above. The coil 20 may be manufactured using a copper (Cu) wire, but is not limited thereto.

The conductive resins 31 and 32 may prevent short-circuits between the coil 20 and the electrode 80. The conductive resins 31 and 32 may be disposed in the body 10, and may cover, respectively, the end portions of the lead terminals 21 and 22 of the coil 20. The conductive resins 31 and 32 may be in contact with the external electrodes 81 and 82, respectively. The conductive resins 31 and 32 may be exposed, respectively, at opposing end surfaces of the body 10, for example, the first surface and the second surface of the body opposing each other in the first direction. The cut surfaces in contact with the external electrodes 81 and 82 may also be formed on the conductive resins 31 and 32, and may be coplanar to the cut surfaces of the end portions of the lead terminals 21 and 22.

The conductive resins 31 and 32 may include metal particles and a binder resin. The metal particle may be copper (Cu) particles, nickel (Ni) particles, silver (Ag) particles, or alloy particles thereof. The metal particles may be particularly silver (Ag) particles, but are not limited thereto. The binder resin may be an epoxy resin, a polyimide resin, or the like. The binder resin may be particularly an epoxy resin, but is not limited thereto. The conductive resins 31 and 32 may be formed of these materials to sufficiently cover the end portions of the lead terminals 21 and 22, respectively, to have sufficient connection areas with the external electrodes 81 and 82, and to have excellent electrical connectivity.

The electrodes 80 may serve to electrically connect the coil component 100 and an electronic device to each other when the coil component 100 is mounted in the electronic device. The electrodes 80 may include external electrodes 81 and 82 covering, respectively, opposing end surfaces of the body 10, for example, the first surface and the second surface of the body opposing each other in the first direction. The external electrodes 81 and 82 may each extend to the third to sixth surfaces of the body 10. The respective external electrodes 81 and 82 may include plating layers 81a and 82a each disposed on the first and second surfaces of the body 10 and conductive resin layers 81b and 82b each formed on the plating layers 81a and 82a, respectively. The plating layers 81a and 82a may include copper (Cu), and the conductive resin layers 81b and 82b may include metal particles and a binder resin. The metal particles may be copper (Cu) particles, nickel (Ni) particles, silver (Ag) particles, or alloy particles thereof. The metal particles may be particularly silver (Ag) particles, but are not limited thereto. The binder resin may be an epoxy resin, a polyimide resin, or the like. The binder resin may be particularly an epoxy resin, but is not limited thereto. The plating layers 81a and 82a may be omitted, if necessary or desired. Conductor layers, including one or more selected from the group consisting of nickel (Ni), copper (Cu), and tin (Sn), may be further disposed on the conductive resin layers 81b and 82b. The conductor layers may also include nickel (Ni) layers and tin (Sn) layers sequentially formed by plating.

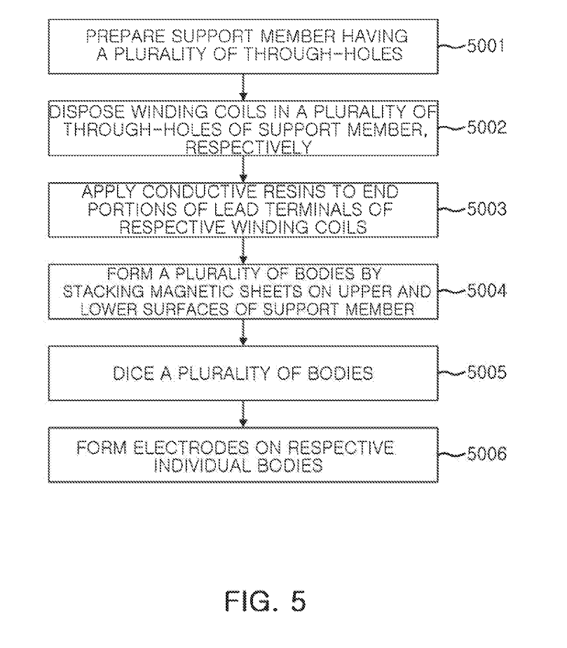

FIG. 5 is a schematic flow chart illustrating an exemplary manufacturing process for the coil component of FIG. 2.

Referring to FIG. 5, a method of manufacturing a coil component 100 according to an exemplary embodiment in the present disclosure may include the following steps. In step 5001, a support member having a plurality of through-holes may be prepared. In step 5002, winding coils may be disposed in the plurality of through-holes of the support member, respectively. In step 5003, conductive resins may be applied to end portions of lead terminals of the respective winding coils. In step 5004, a plurality of bodies may be formed by stacking magnetic sheets on upper and lower surfaces of the support member. In step 5005, the plurality of bodies may be cut. In step 5006, electrodes may be formed on the respective individual bodies. A plurality of coil components may thus be manufactured by one process.

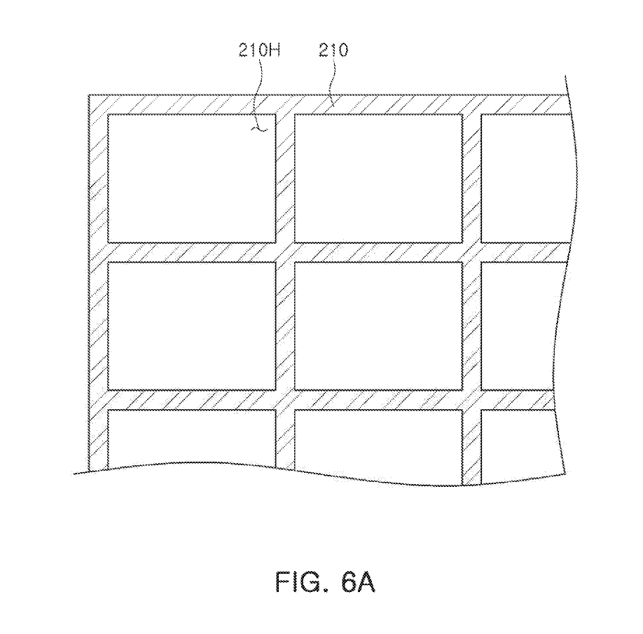

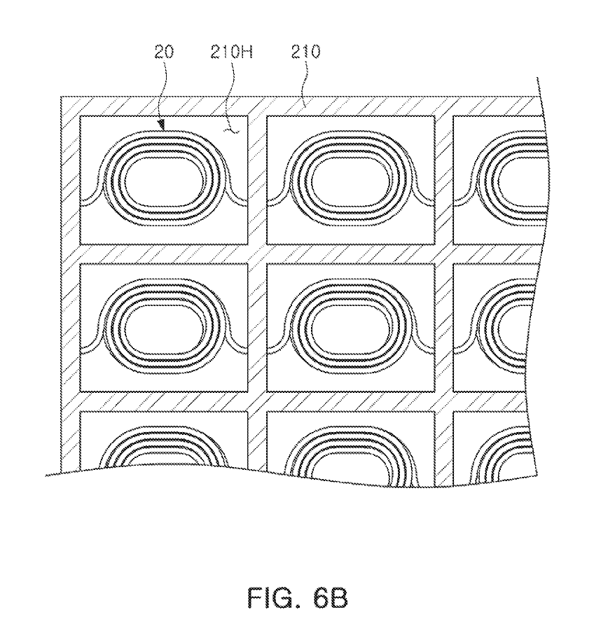

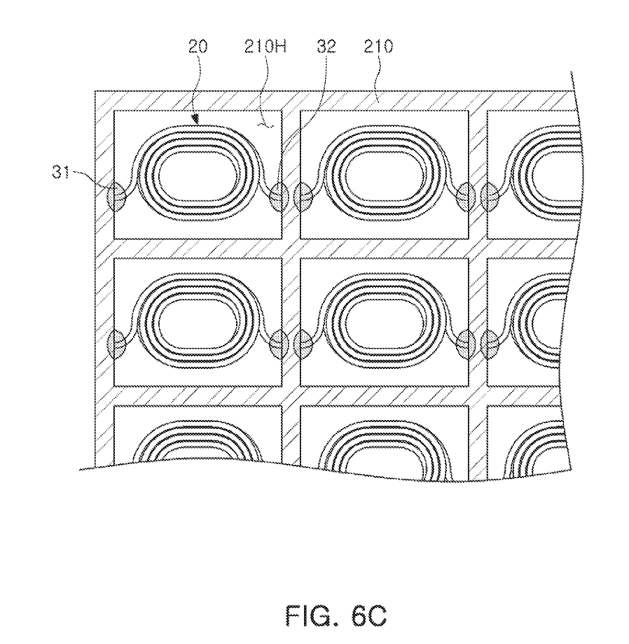

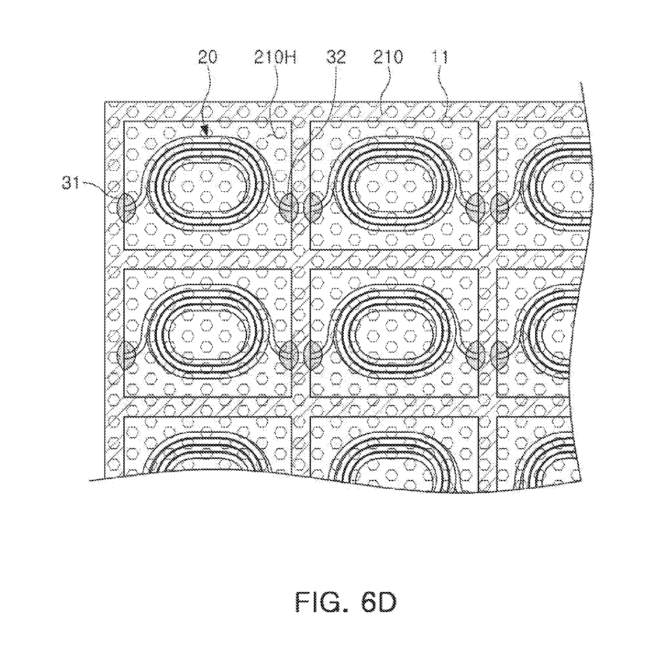

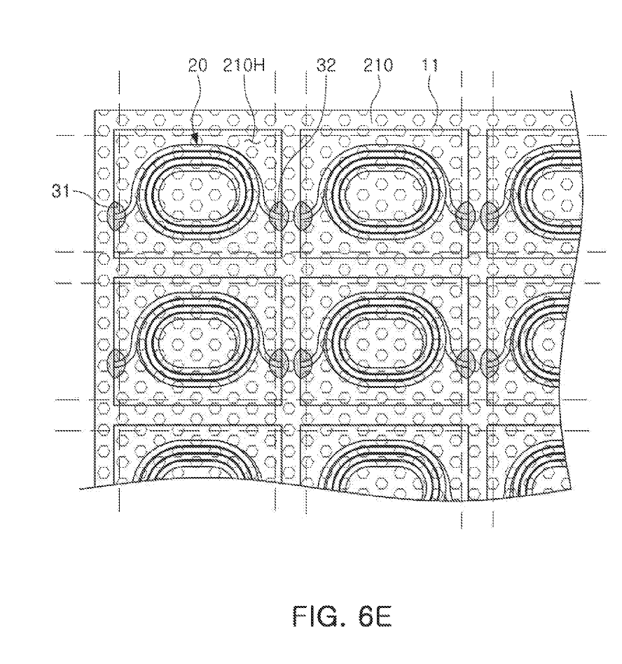

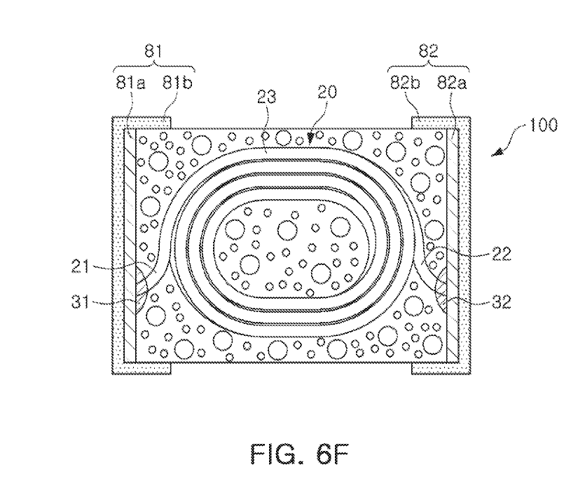

FIGS. 6A through 6F are schematic views illustrating an exemplary manufacturing process for the coil component of FIG. 2.

Referring to FIG. 6A, a support member 210 having a plurality of through-holes 210H may be prepared. A copper clad laminate (CCL), a rolled copper plate, an NiFe rolled copper plate, a Cu alloy plate, a ferrite substrate, a flexible substrate, or the like, may be used as the support member 210. The respective through-holes 210H may have a quadrangular shape, but are not necessarily limited thereto.

Referring to FIG. 6B, coils 20 may be disposed in the respective through-holes 210H. That is, a plurality of coils 20 may respectively be loaded in the plurality of through-holes 210H of the support member 210, which is advantageous in mass production. The respective processed spaces 210H may have sufficiently large sizes in order to accommodate the coils 20 therein. When the coils 20 are accommodated in the through-holes 210H, voids may be formed. The coils 20 may be winding coils formed by a winding method, for example, formed by winding a copper wire 23, but is not limited thereto. End portions of lead terminals 21 and 22 of the coils 20 may be in contact with the support member 210 or be spaced apart from the support member 210 by a predetermined distance.

Referring to FIG. 6C, conductive resins 31 and 32 may respectively be applied to the end portions of the lead terminals 21 and 22 of the coils 20. Solid matters of the applied conductive resins 31 and 32 may completely cover the end portions of the lead terminals 21 and 22, and may also be disposed on the support member 210. The method of applying the conductive resins 31 and 32 is not limited as long as the conductive resins 31 and 32 may be sufficiently dispersed to the end portions of the lead terminals 21 and 22, respectively.

Referring to FIG. 6D, magnetic sheets 11 including a magnetic material may be compressed on upper and lower surfaces of the support member 210 and be then hardened to form a plurality of bodies each covering the coils 20. The magnetic sheets 11 may be formed by molding a magnetic material-resin composite in a sheet form, and may be compressed in a B stage. The voids in the through-holes 210H may be filled with a magnetic material such as the magnetic material-resin composite, or the like, by compressing the magnetic sheets 11. When a hardening process is performed as a subsequent process, dislocation of the coils 20 disposed at predetermined positions may be prevented, and deformation of a bar due to movement of the sheets may be prevented.

Referring to FIG. 6E, the plurality of bodies may be cut so that cut surfaces are formed on the end portions of the lead terminal 21 and 22 and the conductive resins 31 and 32. The cutting may be performed depending on a designed size. Individual bodies 10 may thus be provided. The cutting may be performed using a cutting equipment or may be performed using other cutting methods such as a blade, a laser, or the like. When a width between the through-holes 210H of the support member 210 is designed to be smaller than a region (a cutting kerf region) cut by a width of a cutting blade, or the like, the support member 210 may not remain in the individual bodies 10 after the plurality of bodies are cut. That is, the support member 210, which is used to stably seat the coils 20, may not remain in a final component. However, portions of the support member 210 may also remain in the individual bodies 10 by a method of adjusting a cutting width of the cutting blade, or the like, if necessary.

Referring to FIG. 6F, external electrodes 81 and 82 respectively connected to the lead terminals 21 and 22 and respectively connected to the conductive resins 31 and 32, and may be formed on each of the cut bodies 10. The external electrodes 81 and 82 may be formed by forming plating layers 81a and 82a by plating and then applying conductive resins to the plating layers 81a and 82a to form conductive resin layers 81b and 82b. The conductive resins may be applied by a method of printing a paste including a metal having excellent conductivity by dipping, or the like, but are not limited thereto.

As set forth above, according to the exemplary embodiment in the present disclosure, a coil component in which reliability of connection between an internal coil and an external electrode may be improved, and a method of manufacturing the same may be provided.

While exemplary embodiments have been shown and described above, it will be apparent to those skilled in the art that modifications and variations could be made without departing from the scope of the present invention as defined by the appended claims.

What is claimed is:

1. A coil component comprising:
a winding type coil having at least one lead terminal;
a body covering the coil, and including a magnetic material and a conductive resin applied to an end portion of the lead terminal; and
an electrode on the body, and connected to the lead terminal and to the conductive resin.

2. The coil component of claim 1, wherein the conductive resin has a cut surface in contact with the electrode.

3. The coil component of claim 2, wherein the end portion of the lead terminal has a cut surface in contact with the electrode, and
the cut surface of the lead terminal and the cut surface of the conductive resin are coplanar.

4. The coil component of claim 3, wherein the surface of the body that the electrode is on is an end surface, and the cut surface of the lead terminal and the cut surface of the conductive resin are coplanar to the end surface of the body.

5. The coil component of claim 3, wherein an axial direction of the coil is a height direction, a direction perpendicular to the axial direction of the coil and parallel to the end surface is a width direction, and a ratio of a height in the height direction to a width in the width direction is an aspect ratio, the cut surface of the lead terminal has a quadrangular shape with an aspect ratio of 1 or more.

6. The coil component of claim 1, wherein the conductive resin includes metal particles and a binder resin.

7. The coil component of claim 6, wherein the metal particles include silver (Ag), and
the binder resin includes epoxy.

8. The coil component of claim 1, wherein the electrode includes a plating layer formed on at least one surface of the body and a conductive resin layer on the plating layer, and
the conductive resin and the end portion of the lead terminal are in contact with the plating layer.

9. The coil component of claim 8, wherein the plating layer includes copper (Cu), and
the conductive resin layer includes silver (Ag) and epoxy.

10. The coil component of claim 1, wherein the coil is a winding coil including a plurality of layers, and
the respective layers of the winding coil have a plurality of turns.

11. The coil component of claim 10, wherein the winding coil is a wound copper (Cu) wire.

12. The coil component of claim 1, wherein the magnetic material includes metal magnetic powder particles and a resin mixture.

13. The coil component of claim 12, wherein the metal magnetic powder particles are a plurality of metal magnetic powder particles of which average particle sizes are different from each other.

14. The coil component of claim 12, wherein the metal magnetic powder particles include particles on an end surface of the body with at least portions cut.

15. The coil component of claim 1, wherein the external electrode is electrically connected to the lead terminal via a physical connection with the conductive resin.

16. A method of manufacturing a coil component, comprising:
preparing a support member having a plurality of through-holes;
disposing coils in the plurality of through-holes of the support member, respectively, the coils being formed as a winding type and having at least one lead terminal;
applying conductive resins to respective end portions of the lead terminals of the coils, respectively;
forming a plurality of bodies respectively covering the coils by compressing and hardening magnetic sheets including a magnetic material on upper and lower surfaces of the support member;
cutting the plurality of bodies so that cut surfaces are formed on the conductive resins and the end portions of the lead terminals; and
forming electrodes on the cut bodies, the electrodes being connected to the lead terminals and the conductive resins.

17. The method of claim 15, wherein forming the plurality of bodies includes compressing and hardening first and second magnetic sheets on the upper and lower surfaces of the support member, respectively, the first and second magnetic sheets being formed of a magnetic material-resin composite including metal magnetic powder particles and a resin mixture.

18. A coil component, comprising:
a body with first and second end surfaces on opposing sides of the body;
first and second external electrodes respectively on the first and second end surfaces of the body,
wherein the body includes a winding coil component with first and second lead terminals respectively extending towards the first and second end surfaces, and first and second conductive resins respectively on end portions of the first and second lead terminals and respectively connected to the first and second external electrodes.

19. The coil component of claim 18, wherein at least one of the first and second lead terminals extends to the corresponding first or second end surface, and
the at least one lead terminal has a cut surface that is coplanar with a cut surface of the corresponding conductive resin.

20. The coil component of claim 19, wherein the cut surface of the at least one lead terminal has a height in an axial direction of the winding coil component that is equal to or larger than its width in a direction perpendicular to the axial direction.
